(19) United States
(12) Patent Application Publication
(10) Pub. No.: US 2003/0059125 A1
(43) Pub. Date: Mar. 27, 2003

(54) Method for providing position-sensitive information about an object

(76) Inventors: Peter F. Elzer, Goslar (DE); Ralf Behnke, Rossbach (DE); Arno Simon, Clausthal-Zellerfeld (DE)

Correspondence Address: COLLARD & ROE, P.C., 1077 Northern Boulevard, Roslyn, NY, 11576-1696, US

(21) Appl. No.: 10/226,683

(22) Filed: Aug. 23, 2002

(30) Foreign Application Priority Data
Aug. 23, 2001 (DE) 101 40 393.3

(51) Int. Cl. G06K 9/36; G06K 9/00

(52) U.S. Cl. 382/291; 382/181

(57) ABSTRACT

A method for providing position sensitive information about an object has been described. This method is performed using an observation position and an observation direction in relation to the object and selecting information relevant for this observation position and observation direction from an information data bank and displaying this information. In this case, the observation position and observation direction are taken by a learning phase and a recognition phase.

### BACKGROUND

The present invention relates to a method for providing position-sensitive information about an object.

Until now, handbooks have been used for reference during the maintenance and repair of objects, for example, machine tools, and the maintenance and repair work has been performed according to the instructions contained in the handbooks. Thus, the personnel had to look up the necessary information in the handbooks and then perform the instructions on the object. This process took considerable time and the environmental conditions, such as temperature, moisture, and contamination, made the handling of the information documents cumbersome. In addition, the necessity of frequent changes in the direction of vision significantly interferes with the work procedure.

The necessary information about the object should be communicated to the responsible personnel acoustically or visually and this could be done as a function of the respective observation position. This could be performed acoustically through loudspeakers or headphones and visually through a separate display screen or through a display device worn on the body as glasses in which the necessary information is superimposed over the real objects seen through these glasses.

A positioning system has hitherto customarily been used to determine the respective position from which the object is currently observed. The positioning system includes a transmitter in a fixed position in the space and a receiver carried by the observer. These components determine the spatial relationship to the object using electromagnetic, acoustic, such as ultrasound, or optical angle and distance measurement. However, this additionally requires a suitable positioning system. It is also disadvantageous that the precision of the positioning system may be impaired by electromagnetic, acoustic, and/or optical interference fields.

### SUMMARY OF THE INVENTION

One object of the invention is to improve the procedure for providing position-sensitive information about an object. In this case, the observation position and the observation direction for selecting the relevant information from an information databank may be determined solely from the optically recordable features of the object itself.

Thus, the object is achieved by providing a method for providing position sensitive information about an object by determining an observation position and an observation direction in relation to the object. This method includes selecting information relevant for this observation position and observation direction from an information data bank and displaying this information.

The observation position and the observation direction are determined by a learning phase and a recognition phase. The learning phase has as a rule, only to be performed once, since the data sets determined maintain their validity as long as the object is not changed. The determination of the respective current observation position and observation angle then occurs continuously in the recognition phase.

In the learning phase, a finite number of images of the object are recorded from different angles in a first step. The number of images depends on the observation sector relevant for the later recognition and the precision required for determining the observation position and observation direction.

In a second step, the features of the images recorded which are characteristic for recognition are extracted through preprocessing. This measure is used to reduce the data of the feature sets obtained from the individual images for rapid processing by the computing power available during the later recognition and not impairing the recognition reliability through unnecessary details.

The feature sets are then stored in a databank in a third step.

In the recognition phase, in a first step, the object is recorded from an initially unknown observation position using a sensor. Next, the object images having characteristic features are subsequently selected. The procedure in the recognition phase during the first and second steps is similar to the procedure in the learning phase during the first and second steps.

Subsequently, the degree of similarity between the characteristic features extracted in the recognition phase and the stored characteristic features is determined in a third step. The data sets having the greatest similarity, then delimit a range in which the observer is, with high probability, located in an observation position. These data sets having the greatest similarity have assigned observation positions and observation angles.

Finally, the observation position and the observation angle in relation to the object are determined from the degree of similarity in a fourth step. A suitable algorithm can be used to determine intermediate positions, for which no images were recorded.

The sensor can eventually perform a software scan coarsening of the images recorded to increase performance. In this method, the pixels of the individual raster elements are already summed up during the detection and transmitted to the system for direct further processing.

According to a first alternative, a neuronal net is suitable for practical realization of the method. A table driven image recognition method is a second alternative.

If a neuronal net is used, the learning phase of the second step includes preprocessing by scan coarsening of the images recorded and digitization by assigning averaged intensities to elements of the coarsely scanned images.

In this way, there is a reduction of data, which accelerates the data processing for a given computing power and reduces the danger of incorrect interpretations during the processing via the neuronal net if the neuronal net is trained using the selected characteristic features in a fourth step.

The second step of the recognition phase is similar to the second step of the learning phase.

In the third step of the recognition phase, the degree of similarity to the most similar images of the learning phase stored in the learning phase is finally established using the properties of the neuronal net.

If a table driven image recognition method is used, the preprocessing is performed in the learning phase in the second step by a classical image processing method, wherein image features suitable for this image processing method are dissected out. This measure is also used to increase the processing speed at a given computing power.

The preprocessing is also performed in the recognition phase in the second step by a classical image processing method, wherein image features suitable for this image processing method are dissected out. This step is similar to the second step of the learning phase. The advantage is that the same criteria may be used for the recognition phase as for the learning phase and therefore the comparability is improved.

In the third step, the degree of similarity to the most similar images of the learning phase is determined with the aid of a structured comparison of the determined and stored feature sets. Thus, the structured comparison allows the necessary number of comparison steps to be reduced and therefore the processing speed to be increased at a given computing power.

Additionally, in both methods, the recognition phase can be made more precise in the observation position and observation direction after the third step by a postprocessing method performed in a fifth step. For this postprocessing method, the observation positions and observation directions having the highest probability are linked to one another and thus an observation position and observation direction which are most similar to the actual values are determined.

The postprocessing method may, in this case, be an interpolation method or extrapolation method having appropriate weighting of the probabilities.

The images are preferably recorded in the learning phase and the recognition phase using optical sensors, such as video cameras or raster sensors. The expense may be reduced by using commercially available devices.

When the method is performed using a neuronal net, a suitable neuronal net is expediently selected and used from a number of known neuronal nets through previous experience or empirical methods. In this way, an optimal processing speed and position is achieved which is possible for this application.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 shows a schematic illustration of the learning phase reduced to one plane;

FIG. 2 shows a schematic illustration of the recognition phase reduced to one plane; and

FIG. 3 shows spatial position recognition implemented in the exemplary embodiment.

### DETAILED DESCRIPTION OF PREFERRED EMBODIMENTS

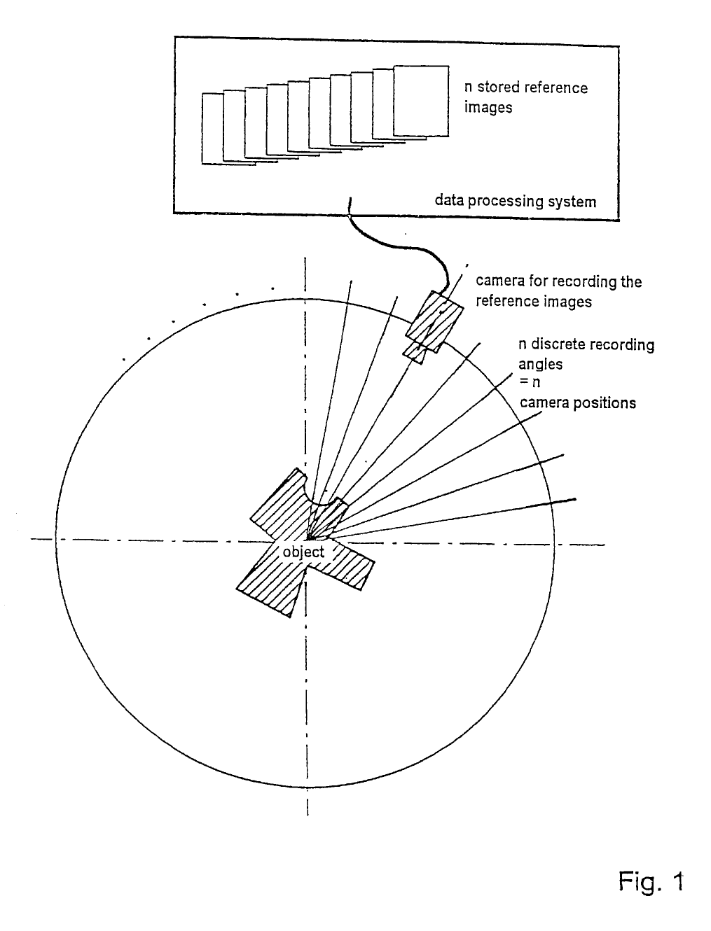

In FIG. 1, an object, whose geometric features are to be recorded, is positioned in the center of a reference circle. A camera for recording the reference images is located on the reference circle. The optical axis of the camera is directed toward the center of the circle and records images of the object. The circle is subdivided into n discrete recording angles which correspond to n camera positions. Individual images are recorded from these camera positions and supplied to a data processing system. The data processing occurs in such a way that first, a data reduction in the form of selection and summary of characteristic features into feature sets is performed and then these feature sets of the individual images are stored. If a neuronal net is used, the neuronal net is simultaneously trained.

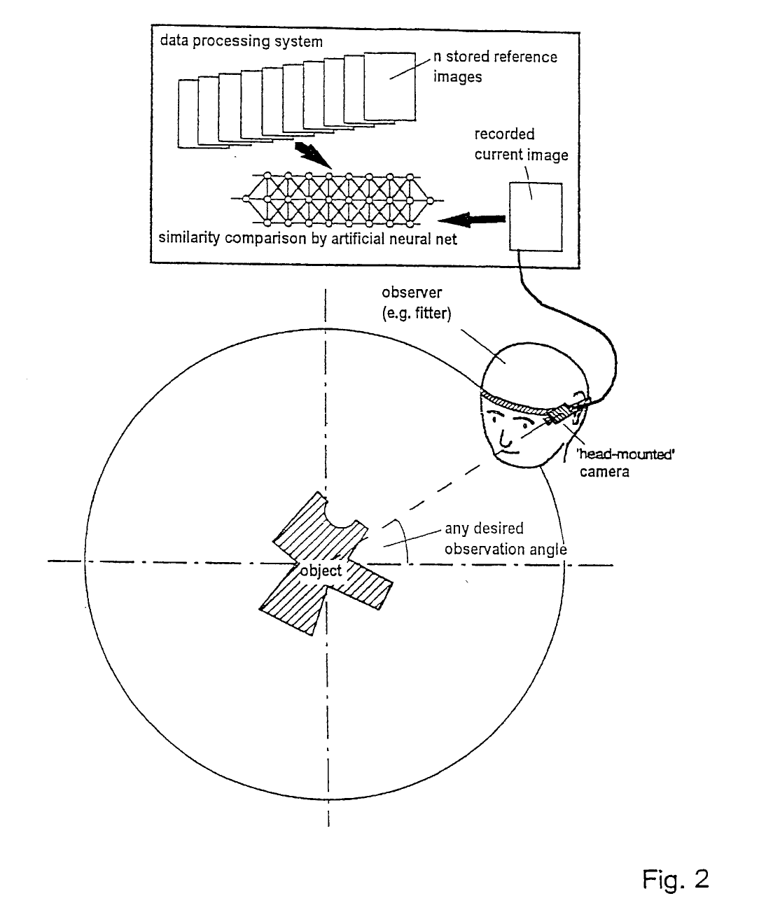

FIG. 2 shows a schematic illustration of the recognition phase. The same object as in FIG. 1 is now located in the field of vision of an observer, e.g., a fitter. The observer carries a camera, mounted on his head, whose optical axis points in the direction of vision of the observer.

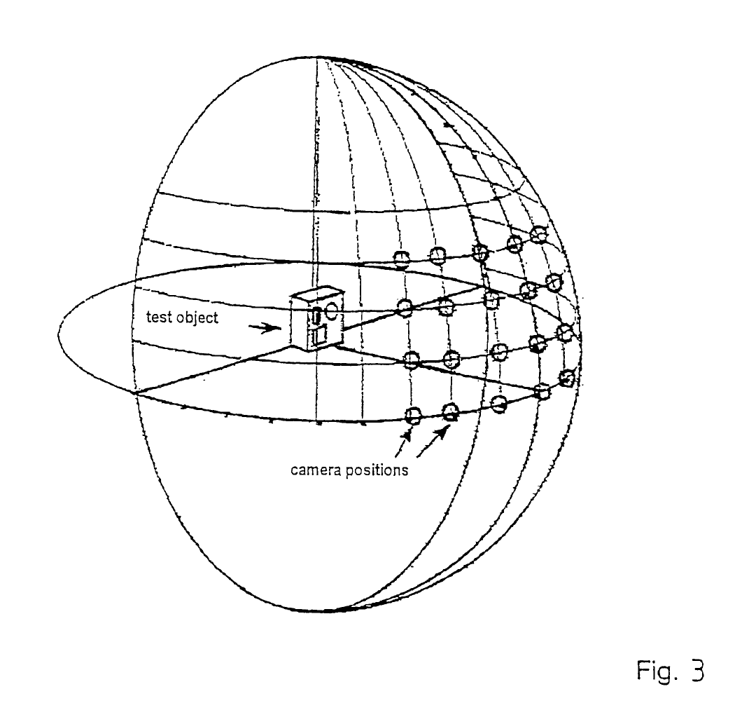

FIG. 3 shows spatial position recognition implemented in this embodiment. The object is again positioned in the center while multiple camera positions are indicated spherically.

An image of the object is recorded by the camera from any desired observation angle and supplied to a data processing system. A data reduction is also initially performed here which preferably corresponds to the data reduction in the learning phase. Using the n stored reference images, the current image recorded is subjected to a similarity comparison by a neuronal net. Under the assumption that the camera is located at the same radius at which the reference images were also recorded, similarities to one or two stored reference images then result. The observation angle in the recognition phase may be determined from the known position from which the reference images were recorded. If the observation angle corresponds exactly to the angle at which one of the n reference images was recorded, the angle of the current recorded image then also corresponds to this observation angle. In other cases, an intermediate position must be determined as a function of the degree of similarity.

Recognition is also possible if the observer assumes a distance to the object which differs from that of the learning phase. In this case, the distance may be automatically established by the method and determined via a scaling factor.

Relevant advice and/or instructions may now be given visually and/or acoustically from a data bank as a function of the current observation position and observation angle. For visual representation, symbols or written instructions may be generated in clear text.

The instructions may also include changing the direction of vision to improve recognition reliability, if a region of the object to be processed does not lie or lies incompletely in the field of vision of the observer.

The device can display an array of further supplementary information, such as status reports, which may be derived from the position of individual controls. In addition, the device can also show changes of the object.

For maintenance work, it is also possible to include replacement parts and the installation positions which they are to assum

Accordingly, while at least one embodiment of the present invention has been shown and described, it is to be understood that many changes and modifications may be made thereunto without departing from the spirit and scope of the invention as defined in the appended claims.

What is claimed is:

1. A method for providing position sensitive information about an object by determining an observation position and an observation direction in relation to the object and selecting information relevant for this observation position and observation direction from an information data bank and displaying this information, the observation direction being taken through a learning phase and recognition phase, the method comprising the steps of:
a) performing a learning phase having the following steps:
i) recording in a first step a finite number of images from different angles;
ii) preprocessing said finite number of images by selecting a plurality of features of said finite number of recorded images wherein these features are characteristic for recognition; and
iii) storing said selected characteristic features in the information data bank; and
b) performing a recognition phase comprising the following steps:
i) recording an object from an initially unknown observation position using a sensor;
ii) selecting characteristic features of the image of the object;
iii) determining the similarity and the degree of similarity between the characteristic features selected in the recognition phase; and
iv) determining the observation position and the observation direction in relation to the object from said degree of similarity.

2. The method as in claim 1, wherein of the step of performing a learning phase, the step of preprocessing the image, includes performing scan coarsening of the recorded images and performing digitization by assigning averaged intensities to elements of the coarse scanned images; and said step of performing a learning phase further comprises a step of training a neuronal net using said selected characteristic features of said images;
and wherein in the recognition phase said step of preprocessing is performed by scan coarsening of the recorded images and further comprises digitizing by assigning suitable intensities to the elements of the coarsely scanned image; and in addition said step of determining the similarity of the characteristic features includes determining the features of the most similar images of the learning phase.

3. The method according to claim 1, wherein for recognition by an image recognition method using control tables, said preprocessing step in said learning phase step includes using a classical image processing method, including dissecting out image features suitable for this image processing method; and wherein in the recognition phase said preprocessing step is performed by a classical image processing method, including dissecting out image features suitable for this image processing method;
and wherein said step of determining the similarity and degree of similarity is determined with the aid of structured comparison of the determined and stored feature sets.

4. The method as in claim 1, wherein the step of performing a recognition phase includes increasing the precision of the observation position and the observation direction by a post processing method performed in a fourth step.

5. The method as in claim 4, wherein the postprocessing method is an interpolation method or an extrapolation method.

6. The method according to claim 1, wherein said steps of preprocessing in said step of performing a learning phase and said step of performing a recognition phase includes using optical sensors such as video cameras and raster sensors.

7. The method as in claim 2 further comprising the step of selecting a suitable neuronal net from a plurality of neuronal nets through previous experience or empirical methods prior to said step of training a neuronal net.
